(19) United States
(12) Patent Application Publication
(10) Pub. No.: US 2014/0298313 A1
(43) Pub. Date: Oct. 2, 2014

(54) METHOD, SERVER, CLIENT AND SYSTEM FOR UPDATING DATA

(71) Applicant: Tencent Technology (Shenzhen) Company Limited, Shenzhen City (CN)

(72) Inventor: Xuewei Yan, Shenzhen City (CN)

(21) Appl. No.: 14/305,419

(22) Filed: Jun. 16, 2014

Related U.S. Application Data
(63) Continuation of application No. PCT/CN2013/088271, filed on Dec. 2, 2013.

(30) Foreign Application Priority Data
Jan. 7, 2013 (CN) 201310005204.X

(51) Int. Cl. G06F 9/445

(52) U.S. Cl. CPC G06F 8/65
USPC 717/171

(57) ABSTRACT

A method, server, client and system for updating data are described. The method includes: receiving, by a server, a request for updating data sent from a client, wherein the request for updating data requests to update first data and carries an update identifier of the first data; determining whether the update identifier of the first data is the same as an update identifier of found second data, obtaining a determination result, wherein the second data is the updated data of the first data; and sending an update flag to the client in accordance with the determination result, wherein the update flag indicates whether the second data is the same as the first data. The method stated above may, for example, be applied to the process of refreshing web page.

### CROSS-REFERENCES TO RELATED APPLICATIONS

This application claims priority to and is a continuation of PCT/CN2013/088271, filed on Dec. 2, 2013 and entitled “METHOD, SERVER, CLIENT AND SYSTEM FOR UPDATING DATA”, which claims priority to Chinese Patent Application No. 201310005204.X, entitled “METHOD, SERVER, CLIENT AND SYSTEM FOR UPDATING DATA”, filed with State Intellectual Property Office of PRC on Jan. 7, 2013, each of which are which are incorporated herein by reference in their entireties.

### TECHNICAL FIELD

The present disclosure relates to the technical field of network communication, and in particular to a method, server, client and system for updating data.

### BACKGROUND

At present, a client such as a mobile phone and a tablet PC can update data content which has been obtained. For example, the client may obtain and display web page content through a browser. On receipt of a refreshing instruction, the client sends to a network-side server a request for updating data, and obtains and displays the updated web page content.

In a process of updating data, the client needs to obtain the updated web page content from the network-side server each time upon receiving a refresh instruction. The updated web page content received by the client may be the same as the web page content displayed currently, such as in the case where the network-side server does not generate updated data. This may result in wasted internet traffic, inefficient use of device computing resources, increased draining of device power, or cause unnecessary traffic overhead when the client receives the same web page content repeatedly.

### SUMMARY

A method, server, client and system for updating data provided in the embodiments of the present disclosure can solve the problem of wasting or inefficient traffic caused by refreshing web page content.

According to an embodiment of the present disclosure, it is provided a method for updating data, which includes:

receiving a request for updating data from a client, wherein the request for updating data carries or includes an update identifier of first data;

determining whether the first data is the same as second data by comparing the update identifier of the first data with an update identifier of the second data, wherein the second data is updated data of the first data, and obtaining a determination result; and

sending an update flag to the client in accordance with the determination result, wherein the update flag indicates whether the second data is the same as the first data.

According to an embodiment of the present invention, it is further provided a method for updating data, which includes:

generating a request for updating data, wherein the request for updating data carries or includes an update identifier of first data;

sending the request for updating data with the update identifier of the first data to a server, to facilitate the server determining whether the first data is the same as second data by comparing the update identifier of the first data with an update identifier of the second data, wherein the second data is updated data of the first data; and

receiving an update flag from the server and performing a display in accordance with the update flag, wherein the update flag indicates whether the first data is the same as the second data.

According to an embodiment of the present disclosure, it is provided a server, which includes:

a receiving unit, configured to receive a request for updating data from a client, wherein the request for updating data carries or includes an update identifier of first data;

a judging unit, configured to determine whether second data is the same as the first data by comparing the update identifier of the first data with an update identifier of the second data, and obtain a determination result, wherein the second data is updated data of the first data; and

a sending unit, configured to send an update flag to the client in accordance with the determination result generated by the judging unit, wherein the update flag indicates whether the second data is the same as the first data.

According to an embodiment of the present disclosure, it is provided a client, which includes:

a processing unit, configured to generate a request for updating data, wherein the request for updating data carries or includes an update identifier of first data;

a sending unit, configured to send the request for updating data generated by the processing unit to a server, to facilitate the server determining whether the first data is the same as second data by comparing the update identifier of the first data with an update identifier of the second data, wherein the second data is updated data of the first data;

a receiving unit, configured to receive an update flag from the server; and

a displaying unit, configured to perform a display in accordance with the update flag received by the receiving unit, wherein the update flag indicates whether the first data is the same as the second data.

According to an embodiment of the present disclosure, it is provided a system for updating data, which includes a server and a client, wherein:

the client is configured to generate a request for updating data and send the request for updating data to the server, wherein the request for updating data includes an update identifier of first data;

the server is configured to receive the request for updating data from the client, determine whether the first data is the same as second data by comparing the update identifier of the first data with an update identifier of the second data, obtain a determination result, and send an update flag to the client in accordance with the determination result, wherein the update flag indicates whether the second data is the same as the first data; and

the client is configured to receive the update flag from the server and perform a display in accordance with the update flag.

With the method, server, client and system for updating data according to some embodiments of the present disclosure, an update identifier is assigned for data, and in the case where the first data is requested to be updated, it is determined whether the first data is the same as the second data by comparing the update identifier of the first data with the update identifier of the second data, wherein the second data is the updated data of the first data. Then, an update flag which indicates whether the first data is the same as the second data may be sent to the client. The data is not sent to the client repeatedly in the case where the first data is the same as the second data, thus avoiding the server sending the same data to the client repeatedly in the process for updating data. Accordingly, the traffic for refreshing a new web page by the client may be reduced.

### BRIEF DESCRIPTION OF THE DRAWINGS

FIG. 1 is a flow chart of a method for updating data according to an embodiment of the present disclosure;

FIG. 2 is a flow chart of another method for updating data according to an embodiment of the present disclosure;

FIG. 3 is a schematic structural diagram of a server according to an embodiment of the present disclosure;

FIG. 4 is a schematic structural diagram of a client according to an embodiment of the present disclosure;

FIG. 5 is a schematic structural diagram of a client according to an embodiment of the present disclosure; and

FIG. 6 is a schematic diagram of a system for updating data according to an embodiment of the present disclosure.

### DETAILED DESCRIPTION

The technical solutions in the embodiments of the present disclosure will be described clearly and completely hereinafter in conjunction with the drawings in the embodiments of the present disclosure. The described embodiments are only a part but not all of the embodiments of the present disclosure. All the other embodiments can be obtained by those skilled in the art without creative effort on the basis of the embodiments of the present disclosure, which fall within the scope of protection of the present disclosure.

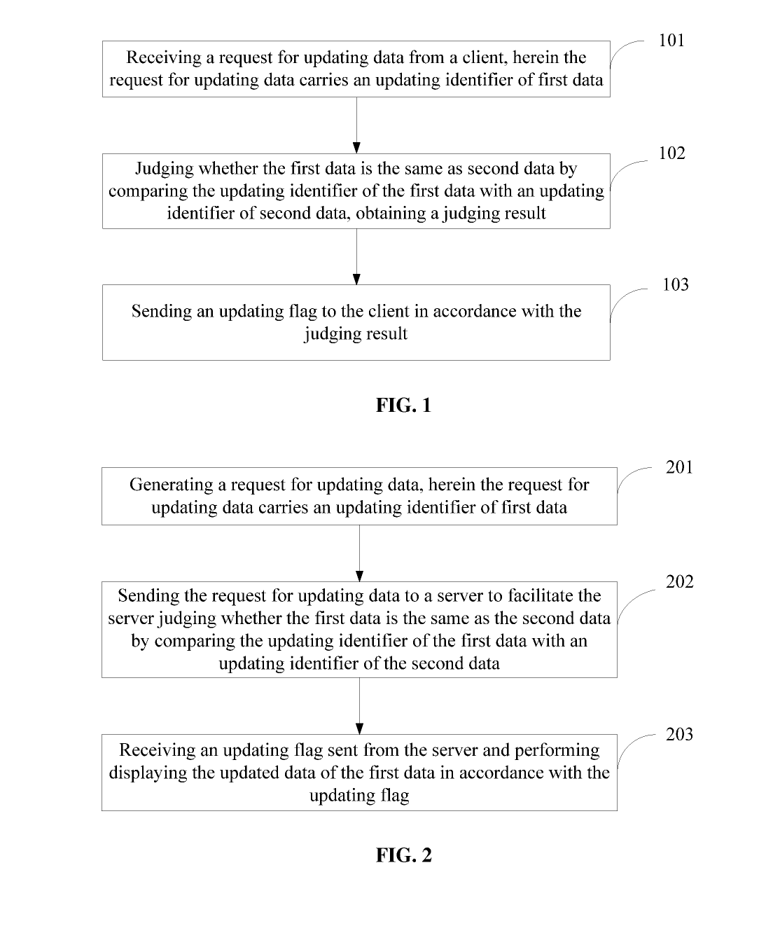

A method for updating data is provided in an embodiment of the present disclosure, and may be applied to a server. As shown in FIG. 1, one exemplary method includes the following steps 101 to 103.

Step 101 may include receiving a request for updating data from a client, wherein the request for updating data carries or includes an update identifier of first data.

The first data to be updated may include page data displayed currently by the client, e.g., webpage data. The update identifier may be used uniquely identify an update state of the first data, and may be generated by the server and sent to the client along with the first data. In some implementations, each time data is updated, the server assigns an update identifier for the updated data. The update identifier may include, but is not limited to, at least one of the following identifiers: an update time of the data, an MD5 value of the data, a hash keyword of the data, a serial number of update data, or a current version number of the data.

Step 102 may include judging or determining whether the first data is the same as second data by comparing the update identifier of the first data with an update identifier of the second data, and obtaining a judging or determination result.

The second data may be the updated data of the first data. For example, the server may search for the recently updated data corresponding to the first data in accordance with the Universal Resource Locator (or referred to as URL) address in the request for updating data. The server may obtain a recent update time of the second data as the update identifier of the second data, and compare the update identifier of the second data with the update identifier of the first data to determine whether the update identifier of the second data is the same as the update identifier of the first data, after the second data is searched.

Step 103 may include sending an update flag to the client in accordance with the judging or determination result.

The update flag may indicate whether the second data is the same as the first data. It is indicated that the second data is the same as the first data in the case where the update identifier of the second data is the same as the update identifier of the first data, and it is indicated that the second data is not the same as the first data in the case where the update identifier of the second data is not the same as the update identifier of the first data.

In some implementations, the update flag may be a binary character. For example, it is indicated that the second data is the same as the first data in the case where the binary character is 1, and it is indicted that the second data is not the same as the first date in the case where the binary character is 0. Alternatively, it is indicated that the second data is the same as the first data in the case where the binary character is 0, and it is indicated that the second data is not the same as the first data in the case where the binary character is 1.

The server may send to the client an update flag occupying, as one exemplary value, one byte. The one byte update flag may indicate whether the second data is the same as the first data. If the second data is the same as the first data, the client may display the first data buffered (i.e., the first data is not updated). If the second data is not the same as the first data, the client may receive and display the second data sent from the server (e.g., instead of displaying the first data).

The server may send the second data and the update identifier of the second data to the client in the case where the determination result of the step 102 indicates that the update identifier of the first data is not the same as the update identifier of the second data.

If the determination result indicates that the update identifier of the first data is not the same as the update identifier of the second data, the server sends the second data as the updated data of the first data to the client, to facilitate the client buffering and displaying the second data as the updated data of the first data. Furthermore, the server may send the update identifier of the second data to the client, to facilitate the client sending the update identifier of the second data to the server for a subsequent data updating request (e.g., which requests to update the second data).

In some embodiments of the present disclosure, an update identifier is assigned for data, and when the first data is requested to be updated, it is determined whether the first data is the same as the second data by comparing the update identifier of the first data with the update identifier of the second data, wherein the second data is the updated data of the first data. Then, an update flag which indicates whether the first data is the same as the second data is sent to the client. The data is not sent to the client repeatedly in the case where the data to be updated is the same as the updated data. Accordingly, traffic overhead can be saved at the client as compared to repeatedly sending the same data.

A method for updating data is further provided in an embodiment of the present disclosure, and is applied to a client. As shown in FIG. 2, the method includes the following steps 201 to 203.

Step 201 may include generating a request for updating data, wherein the request for updating data carries an update identifier of first data.

The first data to be updated may be page data displayed currently by a client, e.g., webpage data. The update identifier may be used to uniquely identify an update state of the first data. For example, the server may generate the update identifier and send the update identifier of the first data to the client along with the first data. In some implementations, each time data is updated, the server assigns an update identifier for the data updated. The update identifier of the first data carried in the request for updating data may have been obtained during a previous update that resulted in the first data. The update identifier may include, but is not limited to, at least one of the following identifiers: an update time of the data, an MD5 value of the data, a hash keyword of the data, a serial number of update data, or a current version number of the data.

Step 202 may include sending the request for updating data to a server to facilitate the server judging or determining whether the first data is the same as the second data by comparing the update identifier of the first data with an update identifier of the second data.

The second data may refer to or include updated data of the first data. The server may search for the second data corresponding to the first data in accordance with the URL address in the request for updating data, obtain a recent update time of the second data (e.g., the most recent update time) as the update identifier of the second data, and compare the update identifier of the second data with the update identifier of the first data to determine whether the second data is the same as the first data.

Step 203 may include receiving an update flag sent from the server and performing a display in accordance with the update flag.

The update flag may indicate whether the first data is the same as the second data. The update flag may be, in some implementations, a binary character. In one example, it is indicated that the second data is the same as the first data in the case where the binary character is 1, and it is indicated that the second data is not the same as the first data in the case where the binary character is 0. In an alternative example, it is indicated that the second data is the same as the first data in the case where the binary character is 0, and it is indicated that the second data is not the same as the first data in the case where the binary character is 1.

The client may display the first data in the case where the update flag indicates that the first data is the same as the second data. In the case where the update flag indicates that the first data is not the same as the second data, The client may receive the second data and the update identifier of the second data sent from the server, buffer and display the second data and store the update identifier of the second data. In addition, the client may further or subsequently generate a request for updating data in accordance with the received update identifier of the second data and send the request for updating to the server to request to update data again (e.g., a request to update the second data).

In some implementations, the server assigns an update identifier for data, and in the case where the first data is requested to be updated, it is determined whether the first data is the same as the second data by comparing the update identifier of the first data with the update identifier of the second data, wherein the second data is the updated data of the first data. Then, an update flag which indicates whether the first data is the same as the second data may be sent to the client. Accordingly, the data is not sent to the client repeatedly in the case where the data to be updated is the same as the updated data (e.g., already updated or does not need to be updated). Accordingly, traffic overhead can be saved at the client as compared with the case that the same data is sent repeatedly.

In accordance with an embodiment of the present disclosure, it is provided a method for updating data. In the case where a client requests the data content of a web home page from a server, the server obtains the data content of the home page and the recent update time of the home page, which may be 14:00. The server may send the obtained content of the home page and the recent update time of the home page as the update identifier to the client. In the case where a user performs home page refreshing operation after he has browsed the content of the home page, the client generates a request for updating data and sends the request for updating data carrying the update identifier 14:00 to the server, for example at 14:05. On receipt of the request for updating data, the server may search for the home page in accordance with the URL address in the request for updating data, and may obtain a recent update time of the home page as 14:03. In this scenario, the server may send an update flag with a value of 1 for example, as well as the data content of the home page updated at 14:03 and the update time 14:03 to the client in the case where the server determines that the update time 14:00 is not the same as the update time 14:03 by comparison. On receipt of the update flag 1, the client may buffer and display the data content of the home page updated at 14:03 and store the update identifier 14:03.

To further illustrate, a user may perform another home page refreshing operation after he has browsed the content of the home page, and the client may generate a request for updating data and send the request for updating data carrying update identifier 14:03 to the server, at 14:10 for example. On receipt of the request for updating data, the server may search for the home page in accordance with the URL address in the request for updating data, and obtain a recent update time of the home page of 14:03. That is, in this exemplary scenario, the data content of the home page has not been updated from 14:03 to 14:10. The server may send an update flag 0 to the client in the case where the server determines that the update time 14:03 in the request of updating data is the same as the update time 14:03 of the content of the home page. On receipt of the update flag 0, the client may display the buffered data content of the home page updated at 14:03.

In some implementations, the update identifier of data is the current version number of the data content. In the case where a client requests the data content of a web home page from a server, the server may obtain the data content of the home page and the current version number of the home page, such as Ver1.0. The server may send the obtained content of the home page and the current version number Ver1.0 of the home page as an update identifier to the client. In the case where a user performs home page refreshing operation after he has browsed the content of the home page, the client may generate a request for updating data and send the request for updating with the update identifier Ver1.0 to the server. On receipt of the request for updating data, the server may search for the home page in accordance with the URL address in the request for updating data, and obtain a current version number of the home page Ver1.1 in this illustration. The server may send an update flag with a value of 1, the data content of the home page of which the version number is Ver1.1, and the update identifier Ver1.1 to the client, in the case where the server determines that the update identifier Ver1.0 is not the same as the update identifier Ver1.1 through update identifier comparison. On receipt of the update flag 1, the client may buffer and display the data content of the home page associated with the version number Ver1.1 and store the update identifier Ver1.1.

To further continue the illustration, a user may perform another or subsequent home page refreshing operation after he has browsed the content of the home page. The client may generate a request for updating and send the request for updating data carrying the update identifier Ver1.1 to the server. On receipt of the request for updating data, the server may search for the home page in accordance with the URL address in the request for updating data, and obtain the current version number of the home page, which may be Ver1.1. In this exemplary scenario, the data content of the home page has not been updated since the client received Ver1.1 of the home page from the server. The server may send an update flag with a value of 0 to the client when it determines that the update identifier Ver1.1 in the request for updating data is the same as the obtained update identifier Ver1.1. On receipt of the update flag 0, the client may display the buffered data content of the home page of which the version number is Ver1.1.

In some embodiments of the present disclosure, an update identifier is assigned for data, and when the first data is requested to be updated, it is determined whether the first data is the same as the second data by comparing the update identifier of the first data with the update identifier of the second data, wherein the second data is the updated data of the first data. Then, an update flag which indicates whether the first data is the same as the second data is sent to the client. The data is not sent to the client repeatedly in the case where the data to be updated is the same as the data stored on the client. Accordingly, traffic overhead can be saved at the client as compared with the case that the same data is sent repeatedly. Further, since the update flag occupies only one or a few binary bytes, traffic overhead can be further saved at the client as compared with the case that the client receives the same data content repeatedly.

In some of the implementations discussed above, the update time of the data and the current version number of the data are used as the update identifier of data. It should be understood by the skilled in the art that any additional or alternative identifiers may be used, such as the serial number of updated data. In this example, when the data is updated, a serial number is assigned for the data.

Another implementation is shown in FIG. 3. As shown in FIG. 3, a server includes: a receiving unit 31, a judging unit 32, and a sending unit 33.

The receiving unit 31 may be configured to receive a request for updating data from a client. The request for updating data may include an update identifier of first data. The update identifier may include, but is not limited to, at least one of the following identifiers: an update time of the data, an MD5 value of the data, a hash keyword of the data, a serial number of update data, and a current version number of the data.

The judging unit 32 may be configured to judge or determine whether the first data is the same as second data by determining whether the update identifier of the first data received by the receiving unit 31 is the same as an update identifier of the second data, and to obtain a judging or determination result. The second data may be updated data of the first data.

The sending unit 33 may be configured to send an update flag to the client in accordance with the determination result generated by the judging unit 32, wherein the update flag indicates whether the second data is the same as the first data.

The sending unit 33 may be further configured to send the second data and the update identifier of the second data to the client in the case where the determination result generated by the judging unit 32 indicates that the second data is not the same as the first data.

The update flag sent from the sending unit 33 may be a binary character. In one exemplary implementation, it is indicated that the second data is the same as the first data in the case where the binary character is 1, and it is indicated that the second data is not the same as the first data in the case where the binary character is 0. Alternatively, it is indicated that the second data is the same as the first data in the case where the binary character is 0, and it is indicated that the second data is not the same as the first data in the case where the binary character is 1.

The server can receive a request for updating data which carries the update identifier of the first data, e.g., in the case where the first data is requested to be updated. The server determines whether the first data is the same as the second data by comparing the update identifier of the first data to determine if it is the same as the update identifier of the second data, wherein the second data is the updated data of the first data. The server may return to the client an update flag which indicates the first data is the same as the second data, e.g., in the case where the first data has been not updated. Thus, the server may avoid sending the same data to the client repeatedly during date updating processes, and the traffic for refreshing a new web page by the client, for example, is reduced.

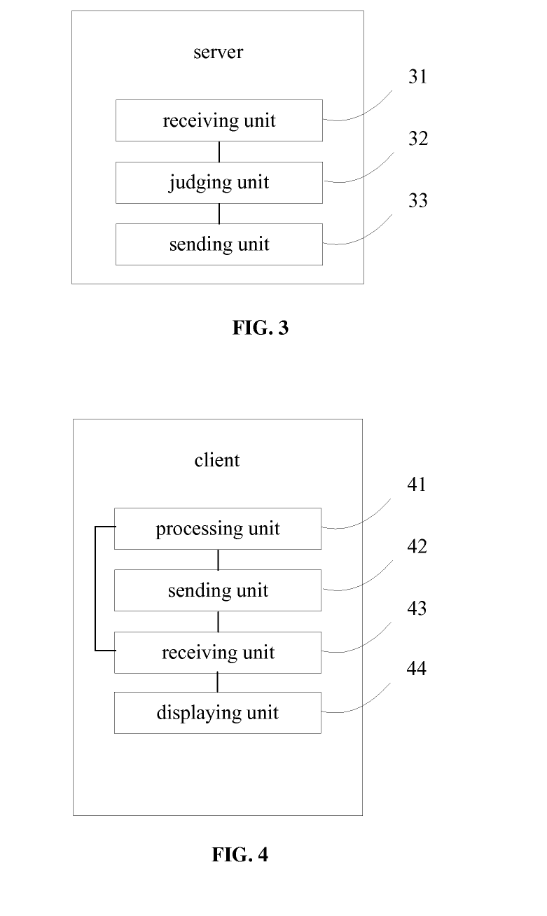

FIG. 4 shows another exemplary implementation according to the present disclosure. As shown in FIG. 4, a client includes: a processing unit 41, a sending unit 42, a receiving unit 43, and a displaying unit 44.

The processing unit 41 may be configured to generate a request for updating data. The request for updating data carries an update identifier of first data. The update identifier may include, but is not limited to, at least one of the following identifiers: an update time of the data, an MD5 value of the data, a hash keyword of the data, a serial number of update data, or current version number of the data.

The sending unit 42 may be configured to send the request for updating data generated by the processing unit 41 to a server, to facilitate the server determining whether the first data is the same as second data by comparing the update identifier of the first data with an update identifier of the second data, wherein the second data is the updated data of the first data.

The receiving unit 43 may be configured to receive an update flag sent from the server.

The displaying unit 44 may be configured to perform a display in accordance with the update flag received by the receiving unit 43, wherein the update flag indicates whether the first data is the same as the second data.

The receiving unit 43 may be further configured to receive the second data and the update identifier of the second data sent from the server in the case where the first data is not the same as the second data.

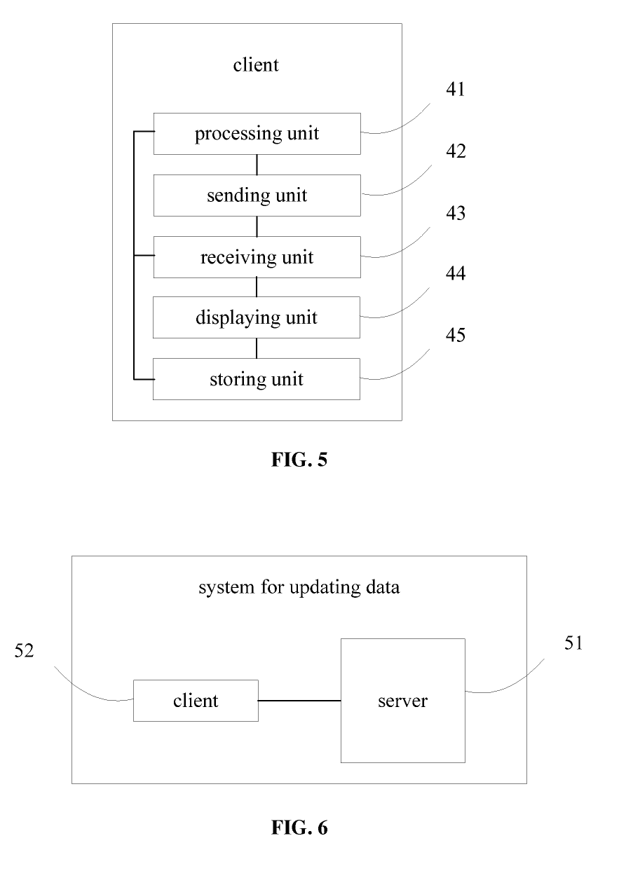

Another client is provided in an embodiment of the present disclosure. As shown in FIG. 5, the client further includes a storing unit 45.

The storing unit 45 may be configured to buffer the second data received by the receiving unit 43 and the first data.

The displaying unit 44 may configured to:

display the first data buffered in the storing unit 45 in the case where the update flag received by the receiving unit 43 indicates that the first data is the same as the second data;

display the second data buffered in the storing unit 45 in the case where the update flag received by the receiving unit 43 indicates that the first data is not the same as the second data.

In some implementations, the update flag received by the receiving unit 43 may be a binary character. For example, it is indicated that the second data is the same as the first data in the case where the binary character is 1, and it is indicated that the second data is not the same as the first data in the case where the binary character is 0. Alternatively, it is indicated that the second data is the same as the first data in the case where the binary character is 0, and it is indicated that the second data is not the same as the first data in the case where the binary character is 1.

A client may send a request for updating data which carries the update identifier of the first data to the server in the case where the first data is requested to be updated. The server judges or determines whether the first data is the same as the second data by comparing the update identifier of the first data with the update identifier of the second data, wherein the second data is the updated data of the first data. The client may receive an update flag sent from the server which indicates the first data is the same as the second data in the case where the first data has been not updated. Thus, the client avoids receiving the same data repeatedly in the process of updating data, and the traffic for refreshing a new web page is reduced.

The client shown in FIG. 4 may be a User Equipment (simply referred to as UE) with network connectivity functionality. Examples of the client include a mobile phone or a computer.

A system for updating data is further provided in an embodiment of the present disclosure in FIG. 6. As shown in FIG. 6, the system includes: a server 51 and a client 52.

The client 52 may be configured to generate a request for updating data and send the request for updating data to the server 51. The request for updating data carries an update identifier of first data. The update identifier may include, but is not limited to, at least one of the following identifiers: an update time of the data, an MD5 value of the data, a hash keyword of the data, a serial number of update data, and a current version number of the data. Specifically, the second data may refer to or include the updated data of the first data.

The server 51 may be configured to receive the request for updating data sent from the client 52, determine whether the first data is the same as second data by comparing the update identifier of the first data with an update identifier of the second data, obtain a determination result, and send an update flag to the client 52 in accordance with the determination result. The update flag may indicate whether the second data is the same as the first data.

The client 52 may be configured to receive the update flag sent from the server 51 and perform display in accordance with the update flag.

Furthermore, the update flag may be a binary character. For example, in one implementation, it is indicated that the second data is the same as the first data in the case where the binary character is 1, and it is indicated that the second data is not the same as the first data in the case where the binary character is 0. Alternatively, it is indicated that the second data is the same as the first data in the case where the binary character is 0, and it is indicated that the second data is not the same as the first data in the case where the binary character is 1.

With the system for updating data according to the embodiment of the present invention, the request for updating data which carries the update identifier of the first data can be sent to the server in the case where the first data is requested to be updated. The server may determine whether the first data is the same as the second data by comparing the update identifier of the first data with the update identifier of the second data, wherein the second data is the updated data of the first data. The client may receive an update flag which indicates the first data is the same as the second data sent from the server in the case where the first data has not been updated. Thus, the client avoids receiving the same data repeatedly in the process of updating data, and the traffic for refreshing a new wet page is reduced.

For any of the embodiments or implementations discussed herein, it can be clearly understood by those skilled in the art that the present invention can be implemented by means of software plus necessary general-purpose hardware, of course can be implemented by hardware, but the former is a preferred embodiment in many cases. Based on such understanding, the technical solution of the present invention in essence or the part contributing to the prior art can be embodied in the form of software product. The computer software product can be stored in readable storage mediums such as a computer floppy, hard disk or optical disk, including several instructions, so that a computer device (which may be a personal computer, a server, or network equipment and the like) performs the methods described in the embodiments of the present disclosure.

The above descriptions are only specific embodiments of the present disclosure, and the scope of protection of the present disclosure is not limited thereto. Any variation or replacement which can be easily thought by those skilled in the art in the technical scope disclosed in the present disclosure should be covered within the scope of protection of the present disclosure. Therefore, the scope of protection of the present disclosure should prevail to the scope of the claims.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

1. A method for updating data, comprising:
receiving a request for updating data from a client, wherein the request for updating data comprises an update identifier of first data;
determining whether the first data is the same as second data by comparing the update identifier of the first data with an update identifier of the second data, wherein the second data is updated data of the first data to obtain a determination result; and
sending an update flag to the client in accordance with the determination result by:
when the update flag indicates the second data is the same as the first data:
sending the update flag to the client; and
when the second data is not the same as the first data:
sending the second data and the update identifier of the second data to the client.

2. The method according to claim 1, wherein the update identifier of the first data and the update identifier of the second data comprise at least one of an update time of data, an MD5 value of data, a hash keyword of data, a serial number of update data, or a current version number of data.

3. The method according to claim 3, wherein the update flag is a binary character, and wherein:
it is indicated that the second data is the same as the first data in the case where the binary character is 1, and it is indicated that the second data is not the same as the first data in the case where the binary character is 0; or,
it is indicated that the second data is the same as the first data in the case where the binary character is 0, and it is indicated that the second data is not the same as the first data in the case where the binary character is 1.

4. A method for updating data, comprising:
generating a request for updating data, wherein the request for updating data comprises an update identifier of first data;
sending the request for updating data to a server with the update identifier of the first data, to facilitate the server to determine whether the first data is the same as second data by comparing the update identifier of the first data with an update identifier of the second data, wherein the second data is updated data of the first data; and
receiving an update flag from the server; and
performing a display in accordance with the update flag, wherein the update flag indicates whether the first data is the same as the second data.

5. The method according to claim 4, further comprising:
receiving the second data and the update identifier of the second data from the server in the case where the first data is not the same as the second data.

6. The method according to claim 5, wherein performing the display in accordance with the update flag comprises:
displaying the first data on a client in the case where the update flag indicates that the first data is the same as the second data; or
displaying the second data on the client in the case where the update flag indicates that the first data is not the same as the second data.

7. The method according to claim 4, wherein the update identifier of the first data and the update identifier of the second data comprise at least one of an update time of data, an MD5 value of data, a hash keyword of data, a serial number of update data, and current version number of data.

8. The method according to claim 7, wherein the updating flag is a binary character, and wherein:
it is indicated that the second data is the same as the first data in the case where the binary character is 1, and it is indicated that the second data is not the same as the first data in the case where the binary character is 0; or it is indicated that the second data is the same as the first data in the case where the binary character is 0, and it is indicated that that the second data is not the same as the first data in the case where the binary character is 1.

9. A server, comprising:
a receiving unit, configured to receive a request for updating data from a client, wherein the request for updating data comprises update identifier of first data;
a judging unit, configured to determine whether the first data is the same as second data by comparing the update identifier of the first data with an update identifier of the second data, and obtain a determination result, wherein the second data is updated data of the first data; and
a sending unit, configured to send an update flag to the client in accordance with the determination result generated by the judging unit by:
when the update flag indicates the second data is the same as the first data, sending the update flag to the client; and
when the update flag indicates the second data is not the same as the first data, send the second data and the update identifier of the second data to the client.

10. A client, comprising:
a processing unit, configured to generate a request for updating data, wherein the request for updating data comprises an update identifier of first data;
a sending unit, configured to send the request for updating data generated by the processing unit to a server, to facilitate the server determining whether the first data is the same as second data by comparing the update identifier of the first data with an update identifier of the second data, wherein the second data is updated data of the first data;
a receiving unit, configured to receive an update flag from the server; and
a displaying unit, configured to perform a display in accordance with the update flag received by the receiving unit, wherein the update flag indicates whether the first data is the same as the second data.

11. The client according to claim 10, wherein the receiving unit is further configured to:
receive the second data and the update identifier of the second data sent from the server in the case where the first data is not the same as the second data.

12. The client according to claim 11, wherein the displaying unit is configured to:
display the first data in the case where the update flag received by the receiving unit indicates that the first data is the same as the second data; and
display the second data in the case where the update flag received by the receiving unit indicates that the first data is not the same as the second data.
